(19) United States
(12) Patent Application Publication
(10) Pub. No.: US 2010/0293113 A1
(43) Pub. Date: Nov. 18, 2010

(54) METHOD AND SYSTEM FOR TRACKING AND COMPENSATION OF DISTRIBUTORS VIA UNIQUE CODES

(75) Inventors: Martin Munzer, Parkland, FL (US); Peter J. Laurence, Scottsdale, AZ (US); George MacEdon, Chandler, AZ (US)

Correspondence Address: ARENT FOX LLP, 1050 CONNECTICUT AVENUE, N.W., SUITE 400, WASHINGTON, DC, 20036, US

(73) Assignee: Cygene Laboratories, Inc., Coral Springs, FL (US)

(21) Appl. No.: 12/373,609

(22) PCT Filed: May 15, 2007
(86) PCT No.: PCT/US07/11554

§ 371 Date: Apr. 26, 2010

Related U.S. Application Data
(60) Provisional application No. 60/800,033, filed on May 15, 2006.

(51) Int. Cl. G06Q 90/00

(52) U.S. Cl. 705/500

(57) ABSTRACT

A method and system for tracking and providing compensation to distributors of a product by using a unique identification code to identify the product at the point of sale, the original customer, and/or the original distributor. A product and/or advertising materials for the product, bearing a unique product code, are provided to distributors. The customer provides the unique product code at the point of purchase of one or more products. The distributor, who promoted the sale of the products, is identified based on the unique product code. Compensation is provided to the distributor based on the number of products sold. The customer may be offered a discount based on the unique product code at the point of purchase.

### CROSS-REFERENCE TO RELATED APPLICATIONS

This application claims the benefit of U.S. Provisional Patent Application Ser. No. 60/800,033, entitled METHOD AND SYSTEM FOR TRACKING AND COMPENSATION OF DISTRIBUTORS VIA UNIQUE CODES, filed May 15, 2006, the entirety of which is incorporated by reference herein.

### BACKGROUND OF THE INVENTION

1. Field of the Invention

The present invention relates to a method and system for tracking and compensation of distributors of products by identifying the original product sold, the original customer, and/or the original distributor, via unique identification codes. In particular, the present invention provides a method and system for tracking and compensation of distributors of anonymous genetic profiling testing products. Other distributors, such as those distributing products sold through retail, direct sales and wholesale, can be compensated in a similar fashion. Furthermore, the present invention provides residual income to the original point of sale or referral source.

2. Description of the Related Art

There are known in the art methods and systems for providing medical tests, including methods and systems for providing genetic testing to individuals on a confidential basis. An example of such methods and systems is provided in PCT Application No. PCT/US2005/015328, entitled “Method and System for a Comprehensive Knowledge-Based Anonymous Testing and Reporting, and Providing Selective Access to Test Results and Report,” the entirety of which is incorporated by reference herein. Many such tests are sold by distributors through retail, direct sales and/or wholesale. However, such tests are generally expensive, and many distributors, e.g., convenience stores, are reluctant to stock such items due to the relatively high inventory costs. Further, the generally high cost of such tests carries with it additional associated costs such as, for example, the costs of monitoring the inventory.

In addition, absent an inventory of medical tests, it is difficult for a test manufacturer to track and compensate a person/entity, such as a distributor, for simply introducing a medical test to a customer who subsequently purchases the medical test from another source, without making an actual sale.

Furthermore, it is known in the art to use coupon codes for providing discounts, rebates and other incentives for consumers to purchase goods. Banner advertising has also been used to brand products and to entice consumers to purchase specific products or brands. Additionally, in recent years, it has become popular for consumer goods to be offered with manufacturer rebate coupons as an incentive for consumers to purchase products and later receive a rebate based on the purchase. There are no known methods and systems, however, for using coupon or rebate codes to track and compensate a distributor or other entity for introducing a medical test to a customer.

There is a need in the art, therefore, for methods and systems that allow compensation of distributors or other entities that introduce a product, such as a medical test, to a customer, without having to stock large inventories of relatively expensive medical tests. There is a further need in the art for methods and systems that allow compensation of distributors or other entities that introduce a product, such as a medical test, to a customer who subsequently purchases the product from another source, without making an actual sale of a medical test to the customer. There is a further need in the art for methods and systems that allow compensation of distributors or other entities that introduce a product, such as a medical test, to a customer who subsequently purchases the product from another source and later purchases additional tests for personal use, or refers others to purchase a test, without making an actual sale of a medical test to the customer. There is a further need in the art for methods and systems that allow tracking and compensation of distributors for introducing a medical test to a customer, by using a coupon, rebate, or other unique code that identifies the original product sold, the original customer, and/or the original distributor.

### SUMMARY OF THE INVENTION

The present invention solves the above identified needs, as well as others, by providing a method and system that allow compensation of distributors for introducing a product to a customer who subsequently purchases the product from another source, without having to stock large inventories of expensive products, and without making an actual sale of a product to the customer, by using a coupon, rebate, or other unique code that identifies the original product sold, the original customer, and/or the original distributor.

One embodiment of the present invention provides a method and system for generating income for retail outlets, advertisers or any other form of product distribution or promotion without an investment or with a small investment in product inventory. The method and system of the present invention are particularly useful when shelf space is limited or the product cost and volume of potential sale do not justify the inventory investment by the retailer. For such purposes, the method and system of the present invention provide the distributor with a method of making the consumer aware of the product and then to profit from the sale of the product through a third party fulfillment center. The information provided to the consumer includes, for example, information concerning the particular product, an Internet web address, a toll-free number and a discount coupon or other unique code. For example, an individual visiting a convenience store sees a banner advertising a DNA paternity test for $99 which offers a 10% discount if a certain store specific coupon code is used when placing the order. If the customer subsequently places the order and uses the discount coupon code, the convenience store owner may later be identified through the coupon code and may receive a commission or other compensation for the customer referral. Similarly, an individual who sees a billboard advertisement can order a product and receive a discount based on the coupon code advertised on the billboard, which would then lead to compensation of the owner of the premises where the billboard is located. Other distribution points or advertising methods can be used similarly to drive sales and determine and compensate the referral source.

The current invention provides for a method and system to track distributors of medical testing kits via unique identification codes. For example, the consumer can purchase a test kit from a third party fulfillment center that ships a prepackaged DNA collection kit including a barcode and password for anonymous access to the test results via the Internet. The exterior of the package may have a separate barcode that can only be correlated to the interior barcode by the laboratory selling the testing service. The exterior barcode is scanned at shipping by the fulfillment center and correlated to the coupon code used by the consumer to receive the discount. The testing laboratory can then identify the original source of the referral when the interior barcode is recorded upon receipt of the specimen that is to be tested and pay a referral fee.

The present invention provides a method and system for implementing coupon codes on advertising or other promotional media that allows the tracking of sales referrals for the purpose of compensating the advertiser, promoter or distributor, by identifying the originating source of introduction to the consumer of a specific product or service.

Other applications of this method and system of tracking referral codes can be used for products that are not sold and submitted anonymously, but that involve direct sales of any products to consumers.

### BRIEF DESCRIPTION OF THE DRAWINGS

The foregoing and other objects, features, and advantages of the invention will become more readily apparent upon reference to the following detailed description of presently preferred embodiments, when taken in conjunction with the accompanying drawings in which:

FIG. 1 illustrates a flow diagram showing one example of tracking and compensating a person or entity that introduces a product to a customer based on a unique code;

FIG. 2 illustrates one example embodiment of the method and system of the present invention;

FIG. 3 illustrates another example embodiment of the method and system of the present invention;

FIG. 4 illustrates exemplary system features for use in accordance with an embodiment of the present invention; and

FIG. 5 illustrates exemplary system components for use with embodiments of the present invention.

### DETAILED DESCRIPTION OF THE INVENTION

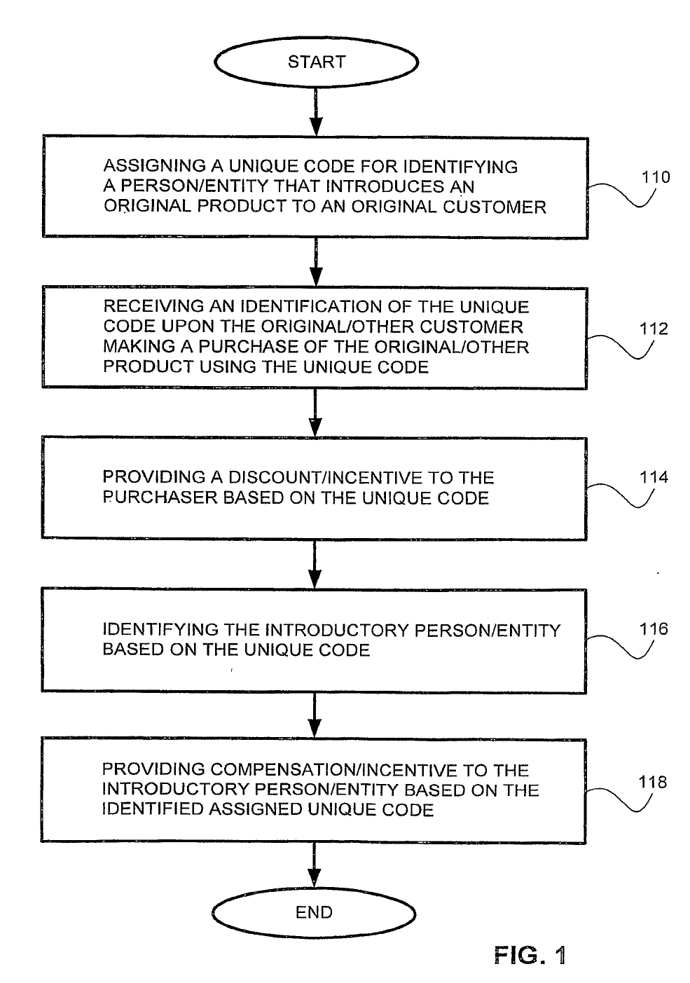

In one embodiment of the present invention, shown in FIG. 1, a method is provided for tracking and compensating distributors for introducing a product to a customer who subsequently purchases the product from another source, without having to stock large inventories of expensive products, and without making an actual sale of a product to the customer, by using a coupon or rebate code, or other identifier, such as a unique code, bar code, serial number, magnetic strip, or Radio Frequency Identifier (RFID) tag, which uniquely identifies the original product sold, the original customer, and/or the original distributor. The method begins with randomly assigning unique identifiers, e.g., codes, for identifying a person/entity that introduces a product, such as a medical test kit, to a customer, and attaching each unique code to the medical test kit, e.g., on the specimen collection card or an exterior of the medical test package, or to an advertisement, flyer, banner, or other material promoting the medical test kit or other product 110. The test kits, advertisements, flyers, banners, and/or other promotional materials are then distributed to distributors, e.g., convenience stores, pharmacies, food and drug stores, or other retail or wholesale entities, for sale, distribution and/or display to customers. The unique identifier may also be a coupon or rebate code, or other incentive for a customer to purchase the advertised product.

Upon a customer's purchase of the product from a third party fulfillment center, e.g., via an Internet web page, toll-free telephone number, or other means, and upon entering the unique code for, e.g., receiving a discount, an identification of the unique code is received 112 at the fulfillment center. The customer may be the original customer who was exposed to the advertising material or who purchased a medical test kit from a distributor, or may be a customer referred by the original customer. The original/referred customer may receive a discount and/or other incentive (e.g., two-for-one sale) upon entering the unique code 114.

Based on the received identified unique code 112, the method of the present invention identifies the person/entity that originally introduced the original customer to the specific product purchased 116. Compensation and/or other incentives are then provided to the person/entity that originally introduced the original customer to the specific product purchased, based on the identified unique code 118.

Although in the embodiment described above the unique code is associated with, e.g., test kit, advertisement, flyer, banner, and/or other promotional materials, thereby identifying the introductory person/entity, other embodiments of the present invention provide for associating the unique code with, e.g. the original customer making a purchase, and tracking and compensation of the introductory entity via the original customer.

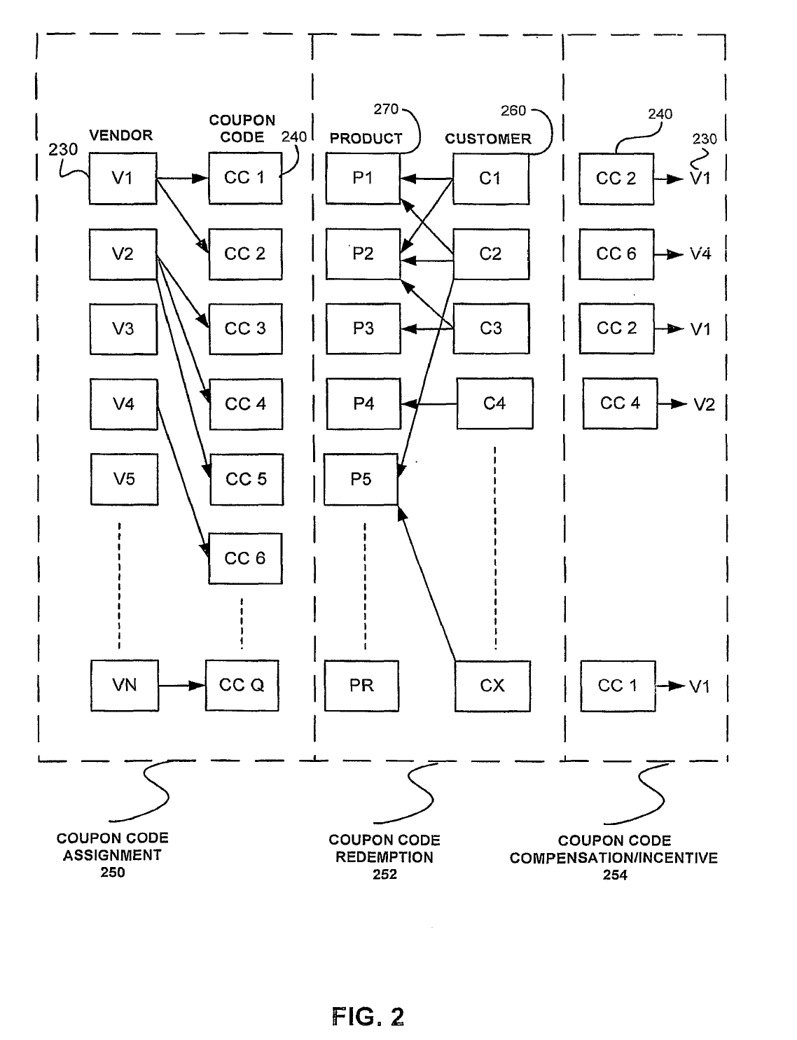

Referring now to FIG. 2, therein shown is one embodiment of the system and for tracking and compensation of the introductory person/entity based on a unique code attached to a purchased product or promotional material advertising a purchased product. As shown in FIG. 2, the system of the present invention may be based on an open system architecture, comprising, for example, of Coupon Code Assignment (CCA) Module 250, Coupon Code Redemption (CCR) Module 252, and Coupon Code Compensation/Incentive (CCC) Module 254.

In CCA 250, each vendor V1-VN 230 is associated with one or more unique coupon codes CC1-CCQ 240. Thus, for example, vendor V1 is associated with coupon codes CC1 and CC2, vendor V2 is associated with coupon codes CC3, CC4 and CC5, vendor V4 is associated with coupon code CC6, and vendor VN is associated with coupon code CCQ.

Referring now to CCR 252, customers C1-CX 260 purchase products P1-PR from a third party, such as a web-based fulfillment center (not shown). For example, customer CC1 purchases products P1 and P2, and enters the unique coupon code CC2 upon making the purchase to receive, e.g., a discounted price from the fulfillment center; customer C2 purchases products P1, P2 and P5, and enters coupon code CC6; customer C3 purchases products P2 and P3, and enters coupon code CC2; customer C4 purchases product P4, and enters coupon code CC4; and customer CX purchases product P5, and enters coupon code CC1.

In CCC 254, the following vendors receive compensation/incentives for introducing products to respective customers: V1, for the sale of products P1 and P2 to customer C1 (based on coupon code CC2), products P2 and P3 to customer C3, who was referred by customer C1 (based on coupon code CC2), and product P5 to customer CX (based on coupon code CC1); V2, for the sale of product P4 to customer C4 (based on coupon code CC4); and V4, for the sale of products P1, P2 and P5 to customer C2 (based on coupon code CC6).

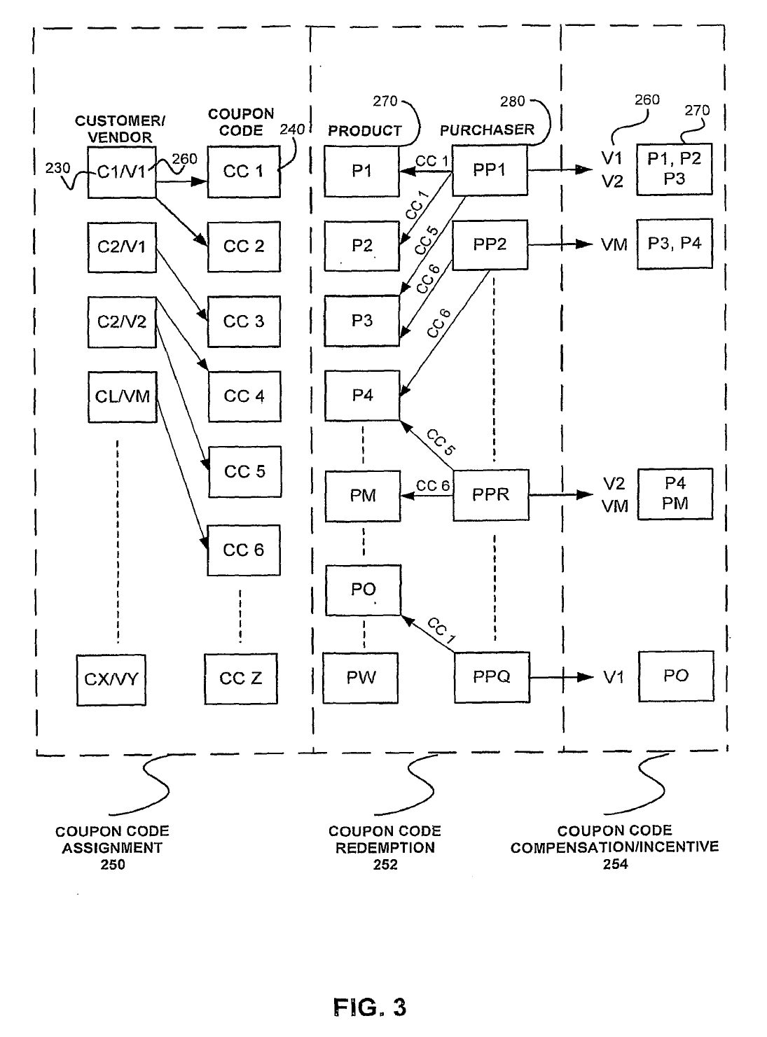

Another embodiment of the present invention will now be described in reference to FIG. 3. In this embodiment, in CCA 250, each vendor V1-VY 260 is associated with one or more customers C1-CX 230, each of which may view and or purchase any number of unique coupon codes CC1-CCZ, at the store of the vendor 260 associated with the customer 230. For example, vendor V1 is associated with customer C1 via coupon codes CC1 and CC2, and with customer C2 via coupon code CC3; vendor V2 is associated with customer C2 via coupon codes CC4 and CC5; and vendor VM is associated With customer CL via coupon code CC6.

In CCR 252, purchasers PP1-PPQ 280 (who may be the same or different from customers 230) purchase P1-PW 270 from a third party fulfillment center (not shown), e.g., via a toll-free telephone number. For example, purchaser PP1 purchases products P1 and P2 using coupon code CC1, and product P3 using coupon code CC5; purchaser PP2 purchases products P3 and P4 using coupon code CC6, purchaser PPR purchases product P4 using coupon code CC5 and product PM using coupon code CC6; and purchaser PPQ purchases product PO using product code CC1.

In CCC 254, the following vendors 260 receive compensation/incentives based on the sale of products 270, for providing/displaying coupon codes 240 products to customers 230, the coupon codes 240 being used by purchasers 280 (who may be the same or different from customers 230) in purchasing products 270: vendor V1, for the sale of products P1 and P2 to purchaser PP1, and for the sale of product PO to purchaser PPQ, all based on coupon code CC1 associated with customer C1, who was introduced to the product and/or provided with coupon code CC1 by vendor V1; vendor V2, for the sale of product P3 to purchaser PP1 and for the sale of product P4 to purchaser PPR, both based on coupon code CC5 associated with customer C2, who was introduced to the product and/or provided with coupon code CC5 by vendor V2; and vendor VM, for the sale of products P3 and P4 to purchaser PP4 and for the sale of product PM to purchaser PPR, both sales based on coupon code CC6 associated with customer CL, who was introduced to the product and/or provided with coupon code CC6 by vendor VM.

It will be recognized by one of ordinary skill in the art that the unique coupon code identifier may be associated with a particular customer, who would subsequently receive compensation and/or other incentives, e.g., in the form of points toward free products, discounts, and others, based on the number of referrals the customer makes to other purchasers, who use the unique identifier associated with the customer in making their purchases. It will further be recognized by those of ordinary skill in the art that the unique coupon code or other identifier may be associated with any entities or persons who subsequently may receive compensation/other incentives for referral of other purchasers of the products, via the use of the unique coupon code or other identifier.

In one embodiment, the purchased medical test kit may include an anonymous identifier, for example but not limited to, labels imprinted with the bar code or a magnetic strip or combination thereof, a serial number, a user-selected identifier, or RFID tag, etc., for including with, or on, a patient specimen receptacle for genetic profile testing. This anonymous identifier associates the specimen with the specific customer. Along with the anonymous identifier, a password selection capability, such as a form on which a password is written, may also be provided in the test kit to permit the customer to select a password, or a random password may be assigned. The password is associated with the anonymous identifier, so that access to the test results cannot be obtained without the proper anonymous identifier and password. The reporting of the test results does not have to be posted on a secured website, as the test results may be mailed to a retail outlet, other distributor, or mail/parcel receipt location where the consumer can retrieve the results by presenting the anonymous identifier and password. The anonymous identifier may be a set of numbers that is presented as a barcode, the first three digits, for example representing a batch or lot number identifying the product and distributor, and the remaining numbers being generated by a random numbers generator imbedded in the inventory control system of the manufacturer or laboratory testing facility.

According to an embodiment of the present invention, the anonymous identifier and password provide access to the test results, which are identified only by the corresponding identifier that was associated with the customer's specimen. The selected password and a copy of the bar code remain in the test kit, associated with the specimen. A second copy of the anonymous identifier is retained by the customer. It is advisable for the customer to memorize or record the password that was selected.

In one embodiment, the test specimen may be collected on or in the specimen receptacle and enclosed in the test kit, along with the password and a copy of the anonymous identifier. The anonymous identifier is the only identifying information in the test kit that associates the customer with the specimen and the test results for that specimen. No other identifying information about the customer is included in the test kit.

The test kit is sealed at the kit assembly site and cannot be opened without obvious damage or destruction of the package. The outside of the test kit may be marked with labels imprinted with a different barcode or a magnetic strip or combination thereof, a serial number, an identifier, or Radio Frequency Identifier (RFID) tag, etc., that can only be cross-referenced with the specimen's anonymous identifier by the receiving laboratory's inventory control system.

In one embodiment, when the customer purchases a test kit from the third party fulfillment center, using a coupon code, the fulfillment center scans the test kit identifier and relates it to the coupon code used during the order process. The test kit is then sent to the specified customer address. After the specimen is collected and enclosed together with the anonymous identifier in the enclosed self addressed return envelope, and then sent to a testing location, such as a laboratory, where the actual test is performed using the specimen.

In one embodiment, no-one at the laboratory has access to any customer information, except the anonymous identifier contained in the test kit. In this manner, the identity of the customer cannot be associated with the test results by anyone at the laboratory. At the third party fulfillment center the customer name and address is known, but neither the anonymous identifier associated with the specimen, nor the customer's password, are known. Thus, anonymity can be assured, since no-one at either the first or second location can match the identity of the customer with the customer's specimen, or with the test results from the specimen.

At predetermined intervals, the third party fulfillment center may electronically transmit a list, spreadsheet, database file, or the like to the inventory control system of the testing laboratory. The information contained in such transmission will include the exterior package identifier, the coupon code used by the consumer to purchase the test kit, and the price paid for the product or service. Based on the transmitted information, the laboratory inventory control system can identify which advertisement, promotion or distributor was the referral source for the sale through the unique coupon code identifier. A referral fee/commission can then be paid by the laboratory to the coupon code assignee.

In one embodiment, a reporting mechanism may be implemented to inform the coupon code assignees of the number of sales attributed to their exposing and/or advertising products to customers. The reporting mechanism may be provided, for example, through a secure interface to a database reflecting the dollar amount purchased and/or number of units sold.

As indicated above, only the fulfillment center is aware of the consumer's identity; the fulfillment center is not aware, however, of the anonymous specimen identifier. At the same time, the testing laboratory does not have access to the consumer's identity, but can report the results to the consumer via secured access over the Internet using access restricted to those with the exact anonymous identifier and password combination. In this way, only the customer, or someone to whom the customer has given the password and the anonymous identifier information, can obtain the test results. In other examples of the present invention, retrieving of the test results may be made over the telephone, or via non-network database driven systems. However, regardless of the medium by which the test results are provided, one feature of an embodiment of the present invention is that the test results can only be accessed using the consumer selected password, and by matching the customer's anonymous identifier to the specific test results.

Similarly, confidentiality can be maintained during the payment process. For example, payment for a test kit may be made by the consumer at a retail outlet or doctor's office. The retail outlet or doctor's office would thereafter remit a portion of the payment to the laboratory without providing patient information. Specimens delivered to the laboratory may be stored and used to provide further testing services to the consumer. Customers may be made aware of other existing and newly-developed tests when accessing their results on a personalized yet anonymous web page, which may be accessed using the customer anonymous identifier and password. Residual income may be provided to the originating distribution channels for any additional tests that the same consumer purchases through the third party fulfillment center.

In one embodiment, while on the personalized web page, the consumer may opt to purchase an additional test at a discount. The portion of the shopping cart that displays the products is hosted on the laboratory's results reporting server. When customers proceed to the checkout to pay for their products, they are directed to a third party fulfillment center that can accept their payment without compromising their anonymity to the testing laboratory. The reporting server generates a unique identifier (checkout ID) that includes the product identification and the price that is to be paid for the service. Once the sale has been completed and payment has been received, the fulfillment center's part of the shopping cart (checkout) reports back to the laboratory's report server that the checkout ID has paid for the product or service. The laboratory references the checkout ID to the anonymous identifier, pulls the corresponding specimen card, runs the test and posts the results to the original anonymous identifier's personalized web page. The laboratory may then also pay the original referral source of the initial product sale a residual commission payment.

In another example of the present invention, a distributor, such as a health food store, fitness center or other retail outlet can sell a generic or specific test kit to a customer without including the cost for the test service. In this method, the distributor purchases the kit at a relatively low price and can resell the product at customary profit margins without incurring high inventory cost. The consumer is made aware that the only product being purchased is the DNA collection kit, and that the kit must be activated through a third party fulfillment center. If the customer fails to activate the kit, the respective DNA sample(s) may be stored for a period of 18 months pending such activation and may ultimately be discarded if no activation is made within that period. In this example, the customer ultimately pays the equivalent or lesser of the regular retail price in a two step process. The distributor or distribution source may be identified by the laboratory by, for example, the product lot number that represents the first several digits of the kits anonymous identifier or, as another example, by the exterior package identifier that is recorded as having been sent to the retailer by the laboratory's inventory control system. Thus, the laboratory can pay a commission to the original distributor when the customers activate and pay for their tests. Further residual income can be provided to the original distributor for any additional tests that a consumer purchases from the third party fulfillment center.

In yet another embodiment of this invention, customers who have already purchased test kits and received their respective results are issued a reusable second purchase or referral discount coupon code that is included in their sealed test kit, or are able to generate a referral discount coupon code while logged on to their personalized results pages. The laboratory then has the ability to compensate the original distributor or point of promotion for the referral made by the original consumer. This form of “viral marketing” can also provide the consumer with other “member benefits,” upon referral by the consumer of additional product(s) purchasers (based on, e.g., entry of the unique coupon code or other identifier), such as a larger discount on additional purchases made for personal use, earning of “points” toward free tests, and others. For example, the system of the present invention may allow the coupon codes to be used by a consumer to earn free additional tests for personal use or for friends/relatives if a certain number of code referrals are made.

For example, a customer can purchase one test for personal use, and then may refer several family members by providing them with the kit-specific coupon code or by generating multiple coupon codes on the customer's personal results webpage, one for each referral. Once the laboratory has received payments by the referred customers, it can either offer a free new test to the customer based on the customer's specimen as stored at the laboratory, or the system can allow the consumer to generate yet another coupon upon logging into the customer's personalized anonymous reports page, which may be redeemable, for example, for a free test when the customer enters the coupon code at the shopping cart. The checkout ID will inform the fulfillment center that the test kit is free and the consumer will only be asked to pay for shipping and handling, and a shipping address. In one embodiment, the individual can order additional tests that constitute such tiers, for example. In particular, in this example, a customer can elect to use the free testing for personal use or as a gift to someone else.

In one embodiment, the customer may receive notification of eligibility (e.g., that the customer has earned the requisite number of points) for a free test or other incentive/discount. This notification may be received, for example, on the customer's personalized reports web page. In another embodiment, the fulfillment center may notify the customer, e.g., upon a customer's subsequent visit to the fulfillment center's web site, or by other means, such as by mail, phone, or e-mail, of the customer's eligibility for the free test or other incentive/discount.

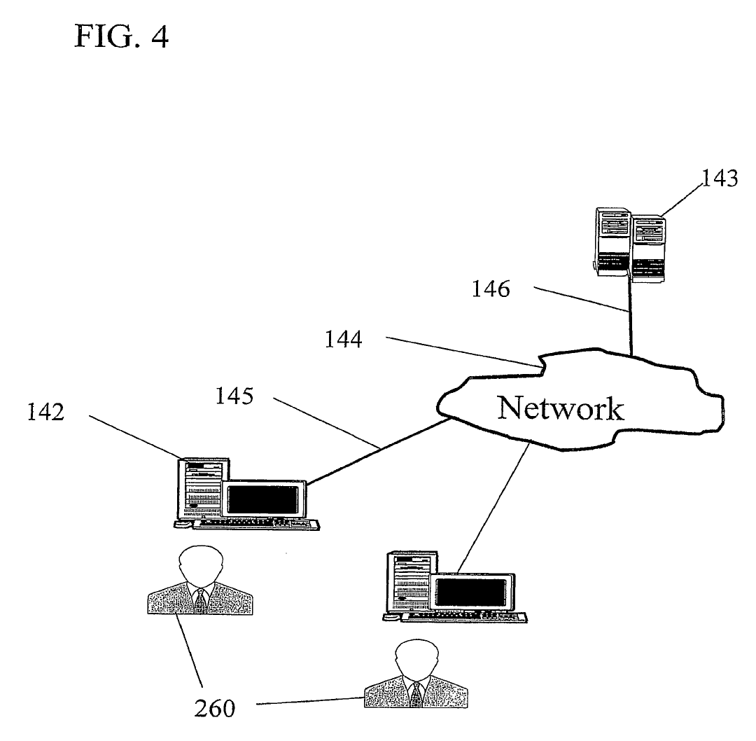

It will be appreciated that the present invention may be implemented in an Internet environment, on a stand-alone computer, in an interactive television environment, or in any other environment that supports storage and display of data. FIG. 4 presents an exemplary system diagram of various hardware components and other features in accordance with an embodiment of the present invention. As shown in FIG. 4, in an embodiment of the present invention, some data for use in the system is, for example, input by a customer 260 (also referred to interchangeably herein as a “user” or “purchaser”) via terminals 1-N142, such as personal computers (PC), minicomputers, mainframe computers, microcomputers, telephonic devices, or wireless devices, such as hand-held wireless devices coupled to a server 143, such as a PC, minicomputer, mainframe computer, microcomputer, or other device having a processor and a repository for data and/or connection to a processor and/or repository for data, via, for example, a network 144, such as the Internet or an intranet, and couplings 145, 146. The couplings 145, 146 include, for example, wired, wireless, or fiberoptic links. In another embodiment, the method and system of the present invention operate in a stand-alone environment, such as on a single terminal.

In operation, in an embodiment of the present invention, via the network 144, product data, unique code data, transactional data, order and tracking data, and/or other information is communicated with and stored on the server 143 (e.g., electronically).

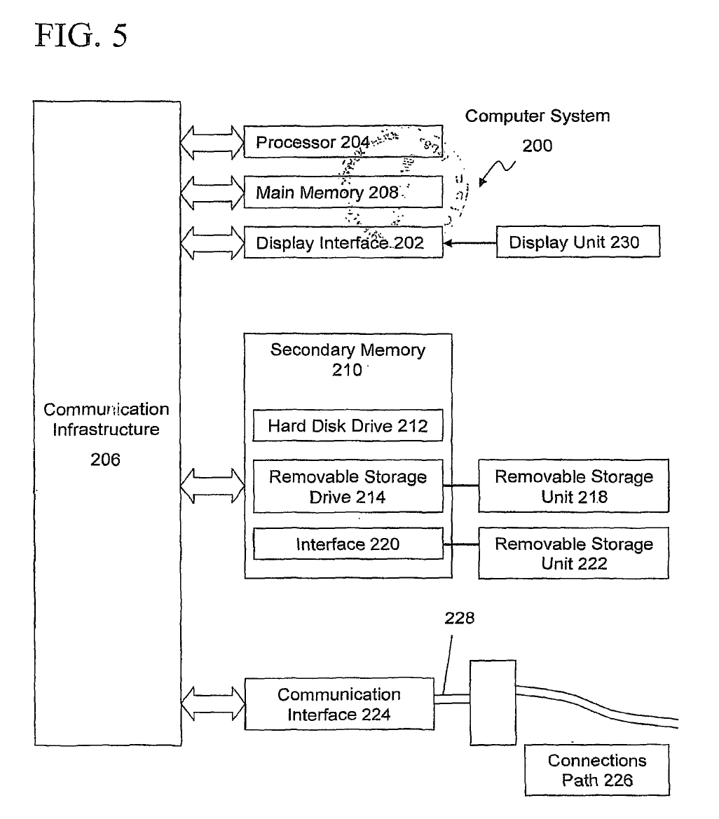

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 5.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In one embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While the invention has been described in detail in particular embodiments using specific examples, it would be appreciated by those skilled in the art that various modifications of those details could be developed in light of the overall teaching of the disclosure. For example, while the invention has been described in terms of a method and system for tracking and compensation of distributors of medical test products, the invention is equally applicable to distributors, including retailers and wholesalers, of other products and services. The particular embodiments disclosed herein are intended to be illustrative only and not limiting to the scope of the invention.

1. A method of tracking and providing compensation to distributors of medical test kits, the method comprising:
assigning a unique code to each of a plurality of medical test kits, such that a plurality of unique codes are assigned to the plurality of medical test kits;
receiving one of the plurality of assigned unique codes from a customer purchasing at least one of the plurality of medical test kits;
identifying a distributor of the at least one of the plurality of medical test kits, based on the received one of the plurality of assigned unique codes;
completing a sale of the at least one of the plurality of medical test kits; and
providing compensation to the distributor based on the sale of the at least one of the plurality of medical test kits.

2. The method of claim 1, further comprising:
offering a discount to the customer purchasing the at least one of the plurality of medical test kits, the offer based on the received one of the plurality of assigned unique codes.

3. The method of claim 1, wherein each of the plurality of assigned unique codes is attached to one selected from a group consisting of a packaging of each of the plurality of medical test kits, an interior of each of the plurality of medical test kits, and an advertisement promoting the sale of each of the plurality of medical test kits.

4. A system of tracking and providing compensation to distributors of medical test kits, the system comprising:
means for assigning a unique code to each of a plurality of medical test kits, such that a plurality of unique codes are assigned to the plurality of medical test kits;
means for receiving one of the plurality of assigned unique codes from a customer purchasing at least one of the plurality of medical test kits;
means for identifying a distributor of the at least one of the plurality of medical test kits, based on the received one of the plurality of assigned unique codes;
means for completing a sale of the at least one of the plurality of medical test kits; and
means for providing compensation to the distributor based on the sale of the at least one of the plurality of medical test kits.

5. The system of claim 4, further comprising:
means for offering a discount to the customer purchasing the at least one of the plurality of medical test kits, the offer based on the received one of the plurality of assigned unique codes.

6. The system of claim 4, wherein each of the plurality of assigned unique codes is attached to one selected from a group consisting of a packaging of each of the plurality of medical test kits, an interior of each of the plurality of medical test kits, and an advertisement promoting the sale of each of the plurality of medical test kits.
